(19) United States
(12) Patent Application Publication
(10) Pub. No.: US 2009/0317699 A1
(43) Pub. Date: Dec. 24, 2009

(54) BATTERY OVERHEATING PROTECTION DEVICE AND ELECTRONIC DEVICE HAVING SAME

(75) Inventors: FEI GAO, Shenzhen City (CN); WEN-HAW TSENG, Tu-Cheng (TW); SHIH-FANG WONG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/477,110

(22) Filed: Jun. 2, 2009

(30) Foreign Application Priority Data
Jun. 20, 2008 (CN) 200810302240.1

(51) Int. Cl. H01M 10/50

(52) U.S. Cl. 429/62

(57) ABSTRACT

A battery overheating protection device used in an electronic device is provided. The electronic device includes a main unit configured to implement basic functions of the electronic device and a battery unit configured to supply power to the main unit. The battery overheating protection device includes a temperature monitoring unit, a switch unit and a processing unit. The temperature monitoring unit is configured to store a predetermined temperature value, measure a temperature value of the battery unit and output a signal when the detected temperature value is greater than the predetermined temperature value. The temperature monitoring unit includes at least one thermistor thermally connected to the battery unit. The switch unit is connected between the main unit and the battery unit. The processing unit is configured to receive the signal and open the switch unit when receiving the signal, thereby the battery unit is disconnected from the main unit.

### BACKGROUND

1. Technical Field

The present disclosure relates to batteries, and particularly, to a battery overheating protection device and an electronic device having the same.

2. Description of Related Art

Battery is typically used in portable electronic devices. When the battery is being charged or discharged, the temperature of the battery rises and the battery may overheat. This may result in damage to the battery and the electronic device using the battery.

Therefore, what is needed is to provide a battery overheating protection device and an electronic device having the same, in which the above problem is eliminated or at least alleviated.

### BRIEF DESCRIPTION OF THE DRAWINGS

FIG. 1 is a schematic view of an electronic device including a battery overheating protection device including a temperature monitoring unit, according to an exemplary embodiment.

FIG. 2 is a circuit diagram of the temperature monitoring unit of the battery overheating protection device of FIG. 1.

FIG. 3 is a schematic view of the temperature monitoring unit of FIG. 2.

### DETAILED DESCRIPTION

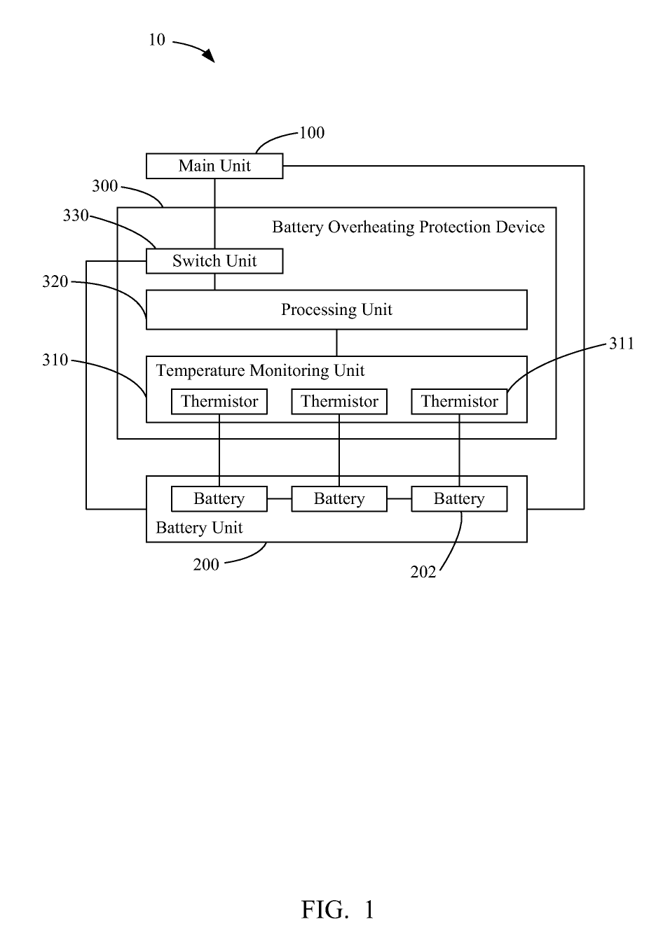

Referring to FIG. 1, an electronic device 10, according to an exemplary embodiment, includes a main unit 100, a battery unit 200, and a battery overheating protection device 300. The electronic device 10 may be a cellular phone or a portable gaming device or other portable electronic devices.

The main unit 100 is configured to implement basic functions of the electronic device 10. For example, for a cellular phone, the main unit 100 may implement a communication function. For a gaming device, the main unit 100 may implement a gaming function. The battery unit 200 is configured to supply power to the main unit 100. In this embodiment, the battery unit 200 includes three batteries 202 connected in series. The main unit 100 may further include a charging circuit (not shown) if the battery unit 200 is rechargeable.

The battery overheating protection device 300 includes a temperature monitoring unit 310, a processing unit 320 and a switch unit 330.

The temperature monitoring unit 310 is configured to store a predetermined temperature value, measure a temperature value of the battery unit 200, and output a signal when the detected temperature value is greater than the predetermined temperature value. In this embodiment, the temperature monitoring unit 310 includes three thermistors 311. Each thermistor 311 is a negative temperature coefficient (NTC) thermistor and is thermally connected to each battery 202, for example, each thermistor 311 may be thermally attached to a surface of each battery 202 by a thermal adhesive (not shown). Thus, the temperature value of each battery 202 is measurable independently and accurately.

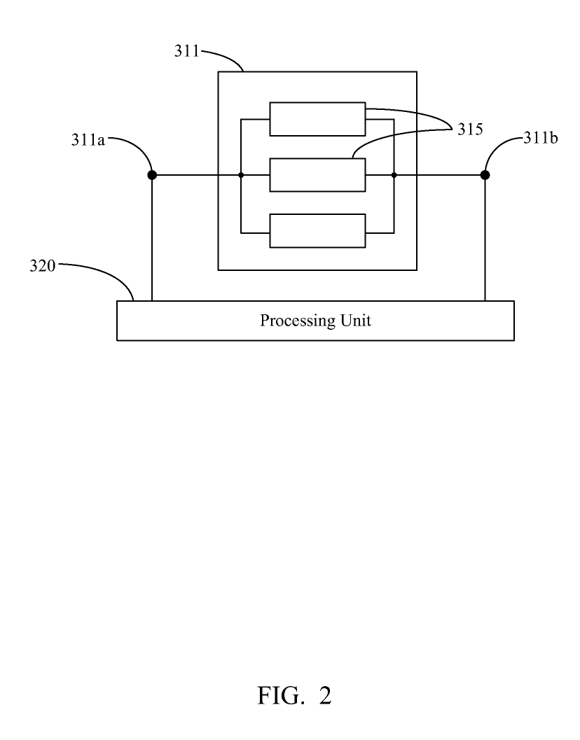

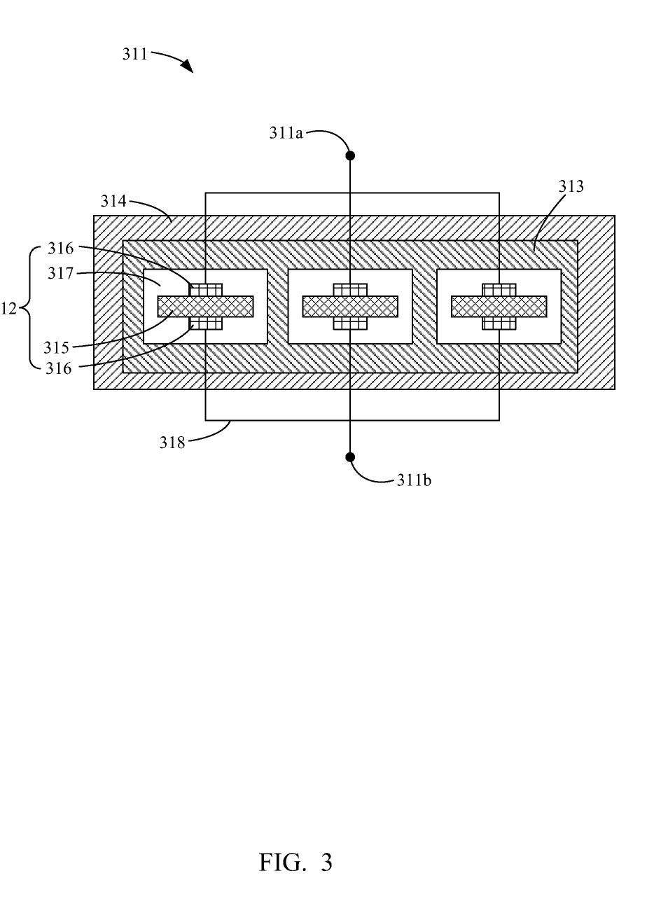

Further referring to FIGS. 2 and 3, the thermistor 311 includes three thermistor cells 312 connected in parallel, a thermal-sensitive resin 313, and a housing 314. The three thermistor cells 312 are packed by the thermal-sensitive resin 313. The housing 314 houses the thermal-sensitive resin 313 for protecting the thermistor cells 312. The housing 314 may be made from organic polymer plastic. Thus, protection for the thermistor 311 is achieved. Furthermore, the thermistor 311 can still function normally even if one of the three thermistor cells 312 is damaged.

The thermistor cell 311 includes a thermistor body 315, two electrodes 316, and a base 317. The thermistor body 315 is positioned on the base 317. The two electrodes 316 are attached to two sides of the thermistor body 315 correspondingly. The base 317 is made from glass-ceramic material. The three thermistor bodies 315 are connected to each other by wires 318.

The processing unit 320 is configured to receive the signal and open the switch unit 330 when receiving the signal. Two terminals 311a, 311b of the thermistor 311 are connected to the processing unit 320.

The switch unit 330 is connected between the battery unit 200 and the main unit 100. The switch unit 330 may include a transistor or other switch unit in the art. When the switch unit 330 is closed, the battery unit 200 supplies power to the main unit 100 and/or can be charged by the main unit 100. When the battery overheats, the temperature monitoring unit 310 outputs the signal to the processing unit 320, the processing unit 320 in turn opens the switch unit 330, thus the electrical connection between the battery unit 200 and the main unit 100 is disconnected. Therefore, when overheating, the battery unit 200 becomes inactive and cools down, thereby protecting the battery unit 200 from damage.

In other embodiment, the electronic device may include one battery including a plurality of battery cells. The thermistors may be thermally connected to the battery cells respectively. The temperature monitoring unit may include one or more thermistors other than three thermistors.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A battery overheating protection device used in an electronic device, the electronic device comprising a main unit configured to implement basic functions of the electronic device and a battery unit configured to supply power to the main unit, the battery overheating protection device comprising:
a temperature monitoring unit configured to store a predetermined temperature value, measure a temperature value of the battery unit, and output a signal when the detected temperature value is greater than the predetermined temperature value, the temperature monitoring unit comprising at least one thermistor thermally connected to the battery unit;
a switch unit connected between the main unit and the battery unit; and
a processing unit configured to receive the signal and open the switch unit when receiving the signal, thereby the battery unit is disconnected from the main unit.

2. The device as claimed in claim 1, wherein the at least one thermistor is a negative temperature coefficient thermistor.

3. The device as claimed in claim 1, wherein the at least one thermistor comprises a plurality of thermistor cells connected in parallel, a thermal-sensitive resin and a housing, and the plurality of thermistor cells are packed by the thermal-sensitive resin, and the housing houses the thermal-sensitive resin.

4. The device as claimed in claim 3, wherein each thermistor cell comprises a thermistor body, two electrodes, and a base; the thermistor body is positioned on the base; and the two electrodes are attached to two sides of the thermistor body correspondingly.

5. The device as claimed in claim 4, wherein the base is made from glass-ceramic material.

6. The device as claimed in claim 3, wherein the housing is made from organic polymer plastic.

7. The device as claimed in claim 1, wherein the switch unit comprises a transistor.

8. The device as claimed in claim 1, wherein the at least one thermistor is thermally attached to a surface of the battery unit by a thermal adhesive.

9. An electronic device, comprising:
a main unit configured to implement basic functions of the electronic device;
a battery unit configured to supply power to the main unit; and
a battery overheating protection device, comprising:
a temperature monitoring unit configured to store a predetermined temperature value, measure a temperature value of the battery unit and output a signal when the detected temperature value is greater than the predetermined temperature value, the temperature monitoring unit comprising at least one thermistor thermally connected to the battery unit;
a switch unit connected between the main unit and the battery unit; and
a processing unit configured to receive the signal and open the switch unit when receiving the signal, thereby the battery unit is disconnected from the main unit.

10. The electronic device as claimed in claim 9, wherein the at least one thermistor is a negative temperature coefficient thermistor.

11. The electronic device as claimed in claim 9, wherein the at least one thermistor comprises a plurality of thermistor cells connected in parallel, a thermal-sensitive resin and a housing, and the plurality of thermistor cells are packed by the thermal-sensitive resin, and the housing houses the thermal-sensitive resin.

12. The electronic device as claimed in claim 11, wherein the thermistor cell comprises a thermistor body, two electrodes, and a base; the thermistor body is positioned on the base; and the two electrodes are attached to two respective sides of the thermistor body.

13. The electronic device as claimed in claim 9, wherein the battery unit comprises a plurality of batteries, the temperature monitoring unit comprises a plurality of thermistors, and each thermistor is thermally attached to a surface of each battery by a thermal adhesive.

14. The electronic device as claimed in claim 9, wherein the electronic device is a cellular phone.

15. The electronic device as claimed in claim 9, wherein the electronic device is a portable gaming device.
